(19) United States
(12) Patent Application Publication
(10) Pub. No.: US 2008/0229944 A1
(43) Pub. Date: Sep. 25, 2008

(54) Device and Method for Screen-Process Printing

(75) Inventors: Ewald Koenig, Wyhl (DE); Elmar Winterhalter, Endingen (DE); Klaus Messmer, Freiburg (DE)

Correspondence Address: CROWELL & MORING LLP;INTELLECTUAL PROPERTY GROUP, P.O. BOX 14300, WASHINGTON, DC, 20044-4300, US

(73) Assignee: THIEME GmbH & Co. KG, Teningen (DE)

(21) Appl. No.: 10/572,400

(22) PCT Filed: Sep. 16, 2004
(86) PCT No.: PCT/EP2004/009528

§ 371 Date: Mar. 27, 2008

(30) Foreign Application Priority Data
Sep. 16, 2003 (DE) 103 44 022.4

(51) Int. Cl. B05C 17/06

(52) U.S. Cl. 101/126

(57) ABSTRACT

A device for screen printing includes a bearing surface for an object which is to printed and a printing mechanism including at least one printing mechanism frame and a doctor blade holder for securing a doctor blade which can be displaceably guided in a longitudinal direction in the printing mechanism frame and which extends in a transversal manner inside the printing mechanism frame. The printing mechanism is arranged in a displaceable manner on a plane extending parallel to the longitudinal direction and at least in a perpendicular manner on the bearing surface, and a mechanism is provided for coordinated displacement of the printing mechanism and doctor blade holder. The device may be used, for example, for printing curved vehicle windshields.

### CROSS-REFERENCE TO RELATED APPLICATIONS

This application is related to co-pending U.S. patent application Ser. No. ______, entitled “Squeegee and Device for Screen-Process Printing”.

### BACKGROUND AND SUMMARY OF THE INVENTION

The invention relates to a device for screen-process printing having a surface for supporting items to be imprinted and a printing mechanism consisting of at least a frame and a squeegee holder extending across the interior of the printing mechanism's frame that may be translated along a longitudinal axis within the printing mechanism's frame for attaching a squeegee.

Those types of devices for screen-process printing are suitable for imprinting planar surfaces. Among other things, glass panes may be imprinted in order to, for example, apply the conductors of a rear-window heater for vehicles. Once the conductors have been imprinted, the rear window may be bent into its final shape. The imprinted inks are baked on simultaneously with the bending of the pane.

A device for imprinting rotationally symmetric solid objects by means of screen-process printing is known from German disclosure statement 214 31 37. In the case of that device, rotationally symmetric solid objects to be imprinted are rolled over a fixed screen and a squeegee is simultaneously moved along the opposite side of the screen. However, that device for screen-process printing is suitable for imprinting exclusively rotationally symmetric solid objects whose outer surfaces to be imprinted may be rolled over a screen.

The purpose of the present invention is to provide a device and a method for the screen-process imprinting of curved surfaces.

According to the invention, a device for screen-process printing is provided. The device has a surface for supporting an item to be imprinted and a printing mechanism. The printing mechanism consists of at least a frame and a squeegee holder extending across an interior of the printing mechanism's frame, which squeegee holder may be translated along a longitudinal axis within the printing mechanism's frame and may have attached a squeegee. The printing mechanism is arranged such that it may at least be translated along a plane orthogonal to the supporting surface and parallel to the longitudinal axis. A control is provided for generating coordinated motions of the printing mechanism and the squeegee.

Since the printing mechanism is arranged such that it may be translated along a plane orthogonal to the supporting surface and parallel to the longitudinal axis, and since a control for generating coordinated motions of the printing mechanism and squeegee is provided, curved surfaces, in particular, convex surfaces, may be imprinted along their long axes, that is, along the squeegee's direction of motion. Since the printing mechanism is translated relative to the supporting surface, an always optimal angular orientation of the screen and squeegee relative to that section of the surface that is currently being imprinted may be set.

In a further development of the invention, the control for generating coordinated motions of the printing mechanism and squeegee may be configured such that it will maintain the printing mechanism's frame tangentially to a surface of the item to be imprinted that is curved, at least along the longitudinal axis i.e. tangentially relative to an imaginary line of contact between the squeegee and an item to be imprinted during a printing motion of the squeegee, and, viewed along the lateral direction.

Employing that approach will provide that both the printing mechanism's frame and a printing screen arranged in the printing mechanism's frame will always be optimally aligned relative to that section of the surface that is currently being imprinted.

In a still further development of the invention, each end of the squeegee holder is guided by a slotted guide on the device's base.

The slotted guides are adapted to suit the curvature of the item to be imprinted in order for the squeegee holder and a squeegee attached thereto to be guided approximately parallel to the surface of the item to be imprinted. That guiding of the squeegee holder by slotted guides will allow ready adaptation to variously curved items to be imprinted by replacing the slotted guides.

In a further development of the invention, the angular orientation of the squeegee holder and its distance from the supporting surface are governed by the slotted guides, where the guides for the squeegee holder that are situated on the printing mechanism's frame are configured such that an angular orientation of the squeegee holder and the printing mechanism's frame will remain constant, at least during a printing motion of the squeegee holder.

Employing that approach will provide that the printing mechanism's frame will be aligned by the squeegee holder in order that the squeegee and the printing mechanism's frame, or screen, will have an optimal angular orientation with respect to one another at all times. That automatic alignment of the printing mechanism's frame on the squeegee holder will allow for a mechanically simple configuration of the device for screen-process printing and, in particular, allow for adapting the device for screen-process printing to imprint variously curved items by merely replacing the slotted guides.

In another development of the invention, a first rolling surface parallel to the slotted guides, on which a second rolling surface of the printing mechanism's frame rolls during a printing motion of the squeegee, is provided.

Employing that approach will allow the printing mechanism's frame to be supported on the first rolling surface, in addition to being guided by the squeegee holder.

In further development of the invention, the first and second rolling surfaces are provided with gear teeth.

Employing that approach will allow for preventing shifting of the printing mechanism's frame parallel to the longitudinal axis during a printing procedure in order to yield high-quality printing results. The gear teeth on the rolling surfaces will keep the printing mechanism's frame parallel to the longitudinal axis, while allowing it to tilt in order to remain tangential to that section of the surface to be imprinted at all times.

In another development of the invention, the angular orientation of the printing mechanism's frame relative to the device's base may be adjusted by several actuators.

Providing that the printing mechanism's frame will be guided by several actuators yields an extremely flexible device for screen-process printing capable of accommodating the varying curvatures of an item to be imprinted by controlling the actions of the actuators in differing manners.

In yet another development of the invention, a controller for controlling the actuators is provided, where the actuators are controlled in a manner that depends upon a surface geometry of an item to be imprinted and a location of the squeegee relative to the item to be imprinted.

For example, a surface geometry of an item to be imprinted may be scanned by the squeegee in a “learning” procedure, or geometric data on an item to be imprinted may be entered directly. During printing procedures, the controller will then determine the angular orientation of the printing mechanism's frame suited to the squeegee's respective locations and control the actuators' actions accordingly.

In a further development of the invention, the actuators are configured in the form of column hoists driven by servomotors.

That sort of configuration will, for example, allow the printing mechanism's frame to be attached to a base by way of four column hoists arranged at the corners of the printing mechanism's frame, which column hoists will provide a stable arrangement thereof, while still being flexibly used.

The problem on which the invention is based is also solved by a screen-process method for imprinting curved surfaces having the stages of reading in a surface contour of an item to be imprinted and aligning a printing mechanism such that a screen frame will be maintained tangential to the item to be imprinted at all times during a printing motion of a squeegee along an imaginary line of contact between the squeegee and the item to be imprinted.

### BRIEF DESCRIPTION OF THE DRAWINGS

Further features and benefits of the invention will be evident from the claims and the following description of preferred embodiments of the invention, together with the figures, which depict:

FIG. 1 is a perspective drawing of a first embodiment of a device for screen-process printing according to the invention;

FIG. 2 is a perspective drawing of a second embodiment of a device for screen-process printing according to the invention;

FIG. 3 is a squeegee for use with the devices for screen-process printing shown in FIGS. 1 and 2; and

FIG. 4 is a squeegee attached to a squeegee holder for use with the devices for screen-process printing shown in FIGS. 1 and 2.

### DETAILED DESCRIPTION OF THE DRAWINGS

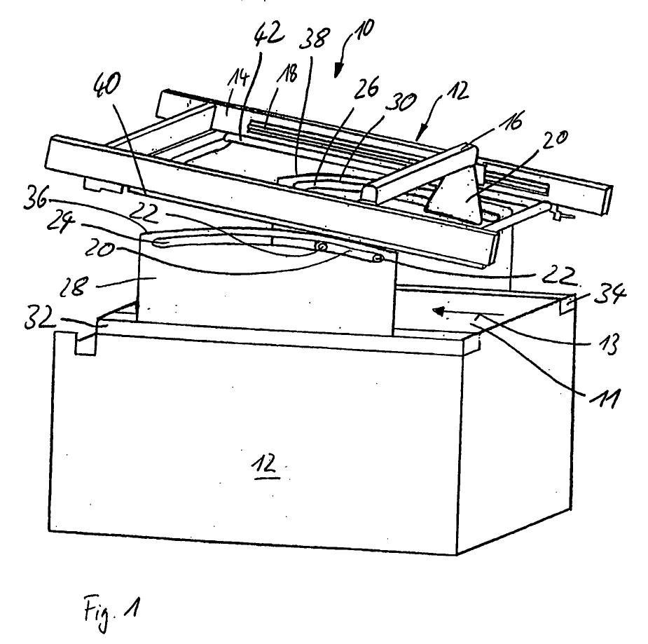

The perspective drawing of FIG. 1 depicts a device 10 for screen-process printing having a supporting surface 11 forming the top surface of a base 12. An item to be imprinted, for example, a vehicle window to be imprinted, is set onto the supporting surface 11. The supporting surface 11 might be supplied by an automatic conveyor, or itself be part of a conveyor. The device 10 for screen-process printing also has a printing mechanism 12 that has a frame 14 and a squeegee holder 16. The squeegee holder 16 extends across the printing mechanism's frame 14, along an axis orthogonal to a longitudinal axis 13, which is indicated by an arrow appearing on the supporting surface 11, and is guided along a pair of mutually parallel, longitudinal, carriers of the printing mechanism's frame 14 on longitudinal guide rails 18, where only one of those guide rails 18 is visible in FIG. 1. The guide rails 18, along with the associated mating components on the squeegee holder 16, are configured such that the squeegee holder 16 and the printing mechanism's frame 14 will assume a constant angular orientation relative to one another at all times while the squeegee holder 16 moves along the guide rails 18. In the case of the depicted device 10 for screen-process printing the squeegee holder 16 and the printing mechanism's frame 14 will remain oriented orthogonal to one another at all times.

The squeegee holder 16 is also provided with a triangular mounting plate 20 on each end, where a tapered end of the mounting plates 20 is fastened to the squeegee holder 16. A pair of longitudinally spaced guide rollers 22 is attached to the broad end of each mounting plate 20. The guide rollers 22 of each mounting plate 20 are arranged in a slotted guide 24, 26. The left-hand slotted guide 24, viewed along the longitudinal direction 13, is provided on a left-hand supporting structure 28, and the right-hand slotted guide 26, viewed along the longitudinal direction 13, is provided on a right-hand supporting structure 30.

Each of the supporting structures 28, 30 are attached to the base 12 by a baseplate 32, 34. The shapes of the slots in the slotted guides 24, 26 track the shape of the surface of an item to be imprinted along the longitudinal axis 13, that is, along, or counter to, a direction of motion of the squeegee 16 relative to the printing mechanism's frame 14 in order that the edge of the squeegee 16 will be guided essentially parallel to a surface of an item to be imprinted when the squeegee holder 16 is translated along the path defined by the slotted guides 24, 26.

The device 10 for screen-process printing may be simply set up for imprinting variously curved items by replacing the baseplates 32, 34, complete with the supporting structures 28, 30, by supporting structures equipped with slotted guides that have been adapted to suit the items to be imprinted.

A printing procedure involves inserting a printing screen (not shown) into the device 10 and clamping a squeegee (also not shown in FIG. 1) in the squeegee holder 16. Ink, which will be forced through the openings in the printing screen when the squeegee holder 16 is translated along the printing mechanism's frame in order to apply that ink to those chosen locations on the item to be imprinted, is applied to the printing screen in a known manner. During such a printing motion, the squeegee holder 16 will be maintained constantly orthogonal to that section of the surface of the item to be imprinted, over which ink is currently being wiped, by the guide rollers 22 riding in the slotted guides 24, 26. The printing mechanism's frame, and thus the printing screen, will therefore be maintained constantly tangential to a section of the surface of the item to be imprinted that is currently being wiped by the squeegee due to the squeegee holder 16 being guided by the guides 18 on the printing mechanism's frame, which will accomplish an optimal printing procedure.

Each of the supporting structures 28, 30 has gear teeth 36, 38 on their top edge, i.e., the edge thereof that faces the printing mechanism's frame 14. Those gear teeth 36, 38 are implemented by stretching a toothed belt across the top edge of each of the supporting structures 28, 30. The undersides of the printing mechanism frame's longitudinal carriers, i.e., those sides thereof situated opposite those gear teeth 36, 38, are also each provided with a toothed rack 40, 42 whose teeth mesh with the teeth 36, 38 on the supporting structures 28, 30. Those intermeshing sets of gear teeth are configured such that shifting of the printing mechanism's frame 14 parallel to the longitudinal axis 13, i.e., relative to the supporting structures 28, 30, will be prevented. During a printing procedure and the motion of the squeegee holder 16 along the path defined by the slotted guides 24, 26, the printing mechanism's frame 14 thus undergoes a tilting motion and rolls along the top edges of the supporting structures 28, 30. Since shifting parallel to the longitudinal axis 13 is precluded by the gear teeth 36, 38 on the supporting structures 28, 30 and the toothed racks 40, 42 on the printing mechanism's frame 14, an accurately printed imprint on the item to be imprinted will be guaranteed.

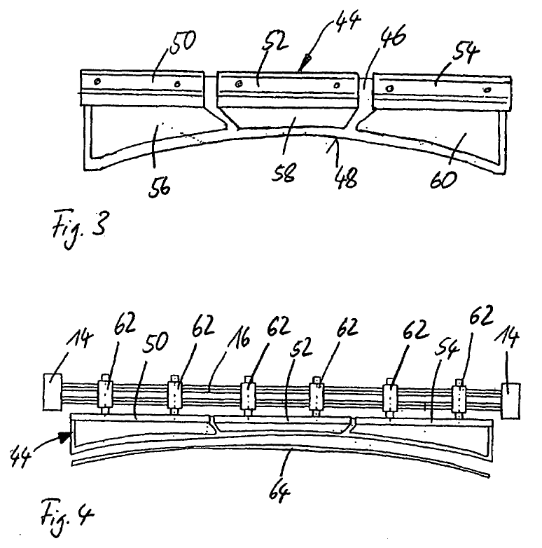

FIG. 3 depicts a frontal view of a squeegee 44 that may be inserted into the squeegee holder 16 of the device shown in FIG. 1. The squeegee 44 has an elastic applicator 46 that extends across the full width of an item to be imprinted and whose printing edge 48, i.e., the edge thereof that faces the item to be imprinted, is curved. That curved printing edge 48 is adapted to suit a lateral curvature of the item to be imprinted. The squeegee 44 is provided with a total of three, spaced, grip segments 50, 52, 54 that are attached to the elastic applicator 46. It should be noted, however, that more than three grip segments might well be provided. Since the only interconnections among the grip segments 50 52, 54 are made via the elastic applicator 48, they are free to move relative to one another. A guide plate 56, 58, 60 that abuts against at least the elastic applicator 48 during a printing procedure and provides for a uniform pressure of its printing edge 48 against the printing screen and the item to be imprinted, protrudes from each grip segment 50, 52, 54. The bottom edges of the guide plates 56, 58, 60, i.e. those edges thereof that face toward the printing edge 48, are parallel to the printing edge 48.

If an item to be imprinted has a constant lateral curvature, the curvature of the printing edge 48 will be chosen to suit that lateral curvature. If the lateral curvature of the item to be imprinted should vary over the long axis of the item to be imprinted, i.e., vary along the direction of motion of the squeegee, the curvature of the printing edge 48 will be chosen to suit an average lateral curvature of the item to be imprinted.

FIG. 4 depicts a particularly beneficial arrangement of the squeegee 44 on the squeegee holder 16. Each of the grip segments 50, 52, 54 is connected to the squeegee holder 16 by a pair of adjusting cylinders 62. Those adjustment cylinders 62 are individually actuatable in order that the pressure exerted by the squeegee 44 on an item to be imprinted may be varied. A positioning of the grip segments 50, 52, 54 relative to the squeegee holder 16 may also be varied. Altering the applied pressure or their relative locations will allow accommodating a varying curvature of the item to be imprinted 64, since the grip segments 50, 52, 54 are free to move relative to one another in order that the squeegee 44 may be deformed by suitably actuating the adjusting cylinders 62.

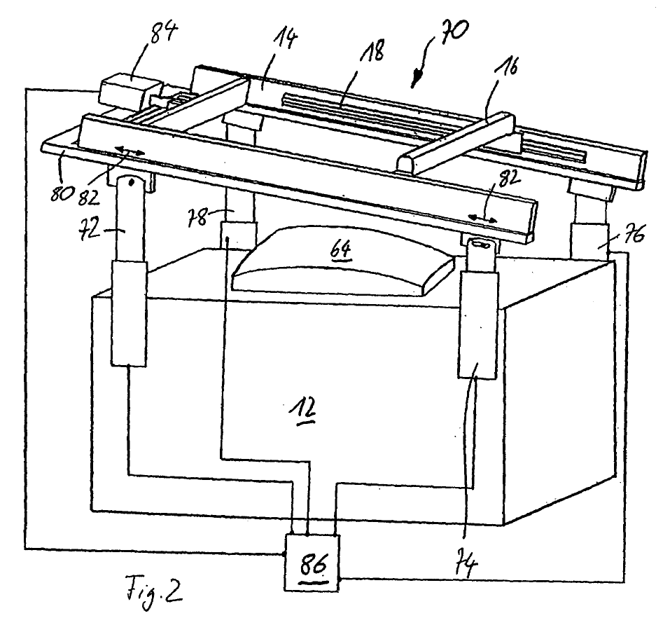

FIG. 2 depicts a schematic perspective drawing of another embodiment of the invention. Components that have the same functions have been assigned the same reference numbers as used in FIG. 1. As in the case of the device shown in FIG. 1, the item 64 to be imprinted, for example, a preformed vehicle window, rests on a supporting surface atop the base 12. The squeegee holder 16 is guided on guide rails 18 situated on the printing mechanism's frame 14. Unlike the device 10 shown in FIG. 1, the frame 14 of the printing mechanism of the device 70 for screen-process printing shown in FIG. 2 is attached to the base 12 by four column hoists 72, 74, 76, 78. Its angular orientation relative to the supporting surface of the base 12 may be adjusted by those column hoists 72, 74, 76, 78. The column hoists 72, 74, 76, 78 are configured in the form of, for example, jackscrews that are adjusted by servomotors. The column hoists 72, 74, 76, 78 are attached to the legs of a U-shaped framework. The column hoists 72 and 74 are attached to a first leg of the framework 80 and the column hoists 76 and 78 are attached to a second leg of the framework 80. The guide rails of the printing mechanism's frame 14 are attached to the legs of the U-shaped framework 80 such that they may be displaced. The printing mechanism's frame 14 is arranged on the framework 80 such that it may be translated parallel to the direction of motion of the squeegee holder 16, that is, translated parallel to the longitudinal axis. That translational degree of freedom of the printing mechanism's frame 14 on the framework 80 is indicated by the double-headed arrows 82. The U-shaped framework 80 is attached to the column hoists 72, 78 by pivotable locating bearings. The U-shaped framework 80 is attached to each of the other column hoists 74, 76 by a floating bearing. Each of those floating bearings is implemented by way of a longitudinal slot in each of the column hoists 74, 76 running parallel to the longitudinal axis and a pin on either side of the framework 80 that is guided in one of those longitudinal slots. That locating/floating suspension of the U-shaped framework on the column hoists 72, 74, 76, 78 will accommodate variations in the distances between the bearings on the column hoists 72, 74, and 78, 76 that will inevitably occur when the framework 80 is tilted.

The printing mechanism's frame 14 may be translated relative to the U-shaped framework 80 by an actuator 84. A translation relative to the framework 80 along the longitudinal axis, or coaxially with the pressure exerted by the printing mechanism's frame 14, during a printing procedure will contribute to improving print quality, since, for example, smearing of imprinted patterns will be hindered.

The column hoists 72, 74, 76, 78 and the actuator 84 are controlled by a controller 86 that is merely schematically depicted. The controller 86 receives or stores geometric data about the surface of the item 64 to be imprinted and controls the column hoists 72, 74, 76, 78, in accordance with the location of the squeegee holder 16 relative to the surface of that item 64, such that the printing mechanism's frame 14 will remain tangential to a section on the surface of that item 64 that is currently being imprinted at all times. The controller 86 receives geometric data on the surface of that item 64 from, for example, a “leaning” procedure, under which the item 64 involved is scanned by a squeegee. Alternatively, the geometric data may be entered directly into a memory of the controller 86. The device 70 shown in FIG. 2 may be particularly easily set up for imprinting variously curved items to be imprinted, since the sole task involved is the transmission of a new set of geometric data to the memory of its controller 86.

1-10. (canceled)

11. A device for screen-process printing, comprising:
a surface for supporting an item to be imprinted;
a printing mechanism including at least a frame and a squeegee holder adapted to hold a squeegee;
wherein the squeegee holder extends across an interior of the printing mechanism's frame and is translatable along a longitudinal axis within the printing mechanism's frame;
wherein the printing mechanism is arranged such that it is at least translatable along a plane orthogonal to the supporting surface and parallel to the longitudinal axis; and
a mechanism for generating coordinated motions of the printing mechanism and squeegee holder.

12. The device for screen-process printing according to claim 11, wherein the mechanism maintains the printing mechanism's frame tangential to a surface of the item to be imprinted, which surface is curved at least along the longitudinal axis, and wherein the tangent is relative to an imaginary line of contact between the squeegee and an item to be imprinted during a printing motion of the squeegee viewed along the lateral direction.

13. The device for screen-process printing according to claim 11, wherein each end of the squeegee holder is guided relative to the supporting surface by a slotted guide.

14. The device for screen-process printing according to claim 12, wherein each end of the squeegee holder is guided relative to the supporting surface by a slotted guide.

15. The device for screen-process printing according to claim 13, wherein an angular orientation of the squeegee holder and its distance from the supporting surface are governed by the slotted guides, wherein the slotted guides for the squeegee holder on the printing mechanism's frame are configured such that an angular orientation of the squeegee holder and the printing mechanism's frame will remain constant, at least during a printing motion of the squeegee holder.

16. The device for screen-process printing according to claim 14, wherein an angular orientation of the squeegee holder and its distance from the supporting surface are governed by the slotted guides, wherein the slotted guides for the squeegee holder on the printing mechanism's frame are configured such that an angular orientation of the squeegee holder and the printing mechanism's frame will remain constant, at least during a printing motion of the squeegee holder.

17. The device for screen-process printing according to claim 13 further comprising at least one first rolling surface parallel to the slotted guides, over which a second rolling surface of the printing mechanism's frame rolls during a printing motion of the squeegee.

18. The device for screen-process printing according to claim 15 further comprising at least one first rolling surface parallel to the slotted guides, over which a second rolling surface of the printing mechanism's frame rolls during a printing motion of the squeegee.

19. The device for screen-process printing according to claim 17, wherein the first and second rolling surfaces are provided with gear teeth.

20. The device for screen-process printing according to claim 18, wherein the first and second rolling surfaces are provided with gear teeth.

21. The device for screen-process printing according to claim 11, wherein an angular orientation of the printing mechanism's frame relative to the supporting surface is adjustable by several actuators of the mechanism.

22. The device for screen-process printing according to claim 12, wherein an angular orientation of the printing mechanism's frame relative to the supporting surface is adjustable by several actuators of the mechanism.

23. The device for screen-process printing according to claim 21, wherein a controller for controlling the actuators is provided, the actuators being controlled in a manner that depends upon a surface geometry of an item to be imprinted and a location of the squeegee relative to the item to be imprinted.

24. The device for screen-process printing according to claim 22, wherein a controller for controlling the actuators is provided, the actuators being controlled in a manner that depends upon a surface geometry of an item to be imprinted and a location of the squeegee relative to the item to be imprinted.

25. The device for screen-process printing according to claim 21, wherein the actuators are configured in the form of column hoists driven by servomotors.

26. The device for screen-process printing according to claim 23, wherein the actuators are configured in the form of column hoists driven by servomotors.

27. A screen-process method for imprinting curved surfaces, the method comprising the acts of:
reading in a surface contour of an item to be imprinted; and
aligning a printing mechanism such that a screen frame is maintained tangential to the item to be imprinted at all times during a printing motion of a squeegee when viewed along an imaginary line of contact between the squeegee and the item to be imprinted.
